(19) United States
(12) Patent Application Publication
(10) Pub. No.: US 2009/0201225 A1
(43) Pub. Date: Aug. 13, 2009

(54) DISPLAY APPARATUS AND MOBILE APPARATUS

(75) Inventors: Naotada OKADA, Kanagawa-ken (JP); Kazuo Horiuchi, Kanagawa-ken (JP); Haruhiko Okumura, Kanagawa-ken (JP); Takashi Sasaki, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 12/350,453

(22) Filed: Jan. 8, 2009

(30) Foreign Application Priority Data
Jan. 9, 2008 (JP) 2008-001890

(51) Int. Cl. G09G 5/00

(52) U.S. Cl. 345/7

(57) ABSTRACT

A display apparatus includes a light-flux-generating section configured to generate a light flux containing image information; a light-flux-controlling section configured to control the light flux and making the light flux come toward a head of an observer, and an image-taking section configured to take an image of the observer. At least one of the light-flux-generating section and the light-flux-controlling section include a movable unit in which at least one of position and focus of the light flux can be adjusted with the observer watching the taken image by the image-taking section.

### CROSS-REFERENCE TO RELATED APPLICATIONS

This application is based upon and claims the benefit of priority from the prior Japanese Patent Application No. 2008-001890, filed on Jan. 9, 2008; the entire contents of which are incorporated herein by reference.

### BACKGROUND OF THE INVENTION

1. Field of the Invention

This invention relates to a display apparatus and a mobile apparatus.

2. Background Art

In a display apparatus, improvement of display brightness, lowering of power consumption, improvement of lifetime, and so forth are required. For example, in a so-called Head-Up Display (HUD) by which various types of driving information are displayed in windshield of movable bodies such as vehicle or airplane and the driving information can be observed with image information of the outer background field at the same time, the problem is that the display brightness is low with respect to the bright surrounding environment in the daytime.

For this problem, the measures of enhancing the brightness with limiting the display region to the eye part and making the light source have longer operating life. However, if the display is narrowed, it becomes necessary that a light flux is appropriately irradiated to the position of the eye of the observer. In particular, when the display region is set to be in a narrow range of only one-eye, it becomes important to adjusting the positions of the display region and the one-eye.

In Patent document 1 (JP-A 3-217339 (Kokai)), there has been proposed a technique of adjusting position of the display region by a member for adjusting angle of an optical unit for adjusting projection direction of light fluxes in an HUD. However, accuracy thereof has been insufficient.

In addition, a technique for person authentication has been disclosed in Patent document 2 (JP 3279913).

### SUMMARY OF THE INVENTION

According to an aspect of the invention, there is provided a display apparatus including: a light-flux-generating section configured to generate a light flux containing image information; a light-flux-controlling section configured to control the light flux and making the light flux come toward a head of an observer; and an image-taking section configured to take an image of the observer, at least one of the light-flux-generating section and the light-flux-controlling section including a movable unit in which at least one of position and focus of the light flux can be adjusted with the observer watching the taken image by the image-taking section.

According to another aspect of the invention, there is provided a display apparatus including: a light-flux-generating section configured to generate a light flux containing image information; a light-flux-controlling section configured to control the light flux and making the light flux come toward a head of an observer; an image-taking section configured to take an image of the observer; and a control section configured to control at least any one of the light-flux-generating section and the light-flux-controlling section based on the taken image by the image-taking section to adjust at least any one of position and focus of the light flux.

According to another aspect of the invention, there is provided a mobile apparatus including: a display apparatus including: a light-flux-generating section configured to generate a light flux containing image information; a light-flux-controlling section configured to control the light flux and making the light flux come toward a head of an observer; and an image-taking section configured to take an image of the observer, at least one of the light-flux-generating section and the light-flux-controlling section including a movable unit in which at least one of position and focus of the light flux can be adjusted with the observer watching the taken image by the image-taking section; and a projection plate to which the light flux output from the display apparatus is projected.

According to another aspect of the invention, there is provided a mobile apparatus including: a display apparatus including, a light-flux-generating section configured to generate a light flux containing image information, a light-flux-controlling section configured to control the light flux and making the light flux come toward a head of an observer, an image-taking section configured to take an image of the observer, and a control section configured to control at least any one of the light-flux-generating section and the light-flux-controlling section based on the taken image by the image-taking section to adjust at least any one of position and focus of the light flux; and a projection plate to which the light flux output from the display apparatus is projected.

### BRIEF DESCRIPTION OF THE DRAWINGS

FIG. 1 is a schematic view illustrating the structure of a display apparatus according to a first embodiment of the invention;

FIG. 2 is a schematic view illustrating the structure of a display apparatus of Comparative example;

FIG. 3 is a schematic view illustrating the structure of a display apparatus according to a second embodiment of the invention;

FIG. 4 is a schematic view illustrating the structure of a display apparatus according to a third embodiment of the invention;

FIG. 5 is a schematic view illustrating the structure of a display apparatus according to a fourth embodiment of the invention;

FIG. 6 is a schematic view illustrating the structure of a display apparatus according to a fifth embodiment of the invention;

FIG. 7 is a schematic view illustrating the structure of a display apparatus according to a sixth embodiment of the invention; and

FIG. 8 is a schematic view illustrating movable bodies according to the invention.

### DETAILED DESCRIPTION OF THE INVENTION

Hereinafter, embodiments of this invention will be specifically explained with reference to drawings.

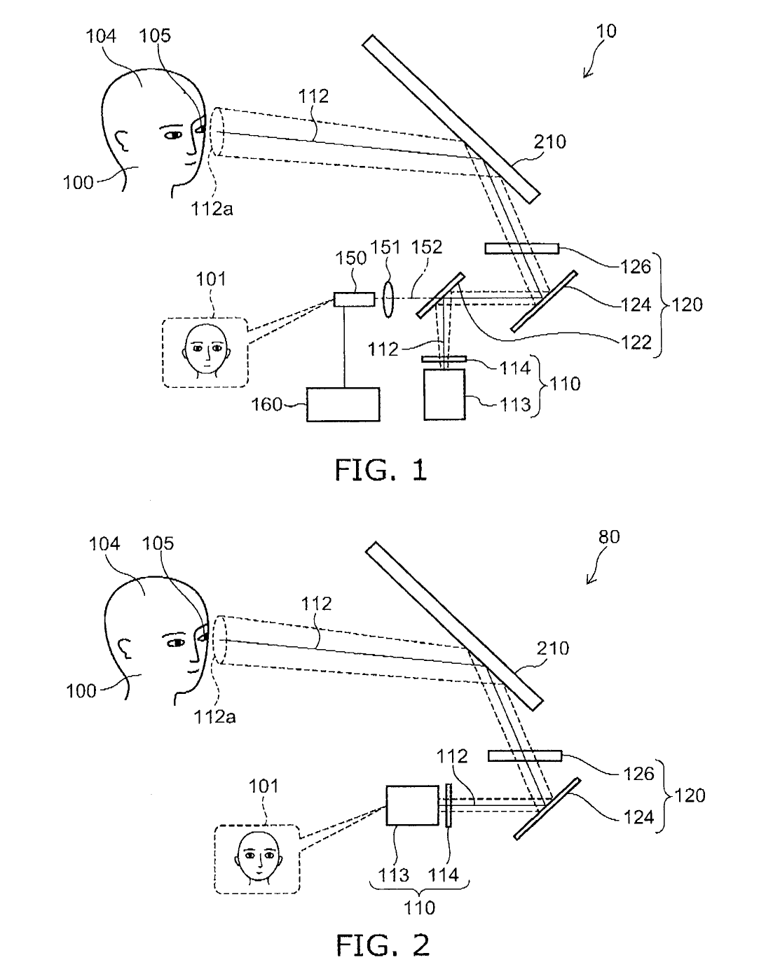

FIG. 1 is a schematic view illustrating the structure of a display apparatus according to a first embodiment of the invention;

As shown in FIG. 1, a display apparatus 10 of a first embodiment of this invention has a light-flux-generating section 110 configured to generate light flux 112 containing image information and a light-flux-controlling section 120 configured to control a light flux 112 to come in a head 104 of an observer 100. The light flux 112 reaches the head 104 of the observer 100 through a projection plate 210.

The light-flux-generating section 110 has a projector 113 and an image unit 114 provided in front thereof. And, the projector 113 and the image unit 114 can move, for example, along the axial direction of the light flux 112.

Moreover, the light-flux-controlling section 120 has a first mirror 122, a second mirror 124, and a lens 126. In the example of FIG. 1, the second mirror 124 can move.

By these movable units, the position and focus of an irradiation region 112a to the observer 100 of the light flux 112 can be adjusted. For example, by changing an angle or the like of the second mirror 124, the position in the left, right, top and bottom of the irradiation region 112a of the light flux 112 can be adjusted. Moreover, by changing the position between the projector 113 and the image unit 114 in the axial direction of the light flux 112, the focus of the light flux 112 can be adjusted. The adjustment of the movable unit may be performed by the observer 100, or may be performed automatically by a control section, which is not shown, as described later.

And, in the display apparatus 10, the image-taking section 150 configured to take an image 101 of the observer 100 obtained through the first mirror 122 is provided. That is, by the transmissive light obtained from the first mirror 122, which is one optical component composing the light-flux-controlling section 120, the image-taking section 150 takes the image 101 of the observer 100. The image-taking section 150 may detect at least any one of a light transmitting an optical component included in the light-flux-controlling section 120 or a light reflected thereby. Thereby, the display apparatus 10 can obtain the image 101 of the observer 100 with high accuracy. Based on the image taken with high accuracy, the position and focus of the irradiation region 112a of the light flux 112 to the observer 100 can be appropriately adjusted.

Specifically, for example, the observer 100 can control the movable units of the light-flux-generating section 110 and the light-flux-controlling section 120 with watching the image of himself taken by the image-taking section 150 and reflected in the projection plate 210, and thereby, can adjust the position or focus of the irradiation region. That is, in order that the light flux surely enters in the eye of the observer 100, the position of the light flux can be adjusted or the focus of the displayed image can be adjusted.

Or, as described later, a control section, which is not shown, is provided, and based on an image of the observer 100 image-taken by the image-taking section 150, the movable units of the light-flux-generating section 110 and the light-flux-controlling section 120 are adjusted, and thereby the position and the focus of the irradiation region can be automatically adjusted. For this purpose, for example, by using an image-recognition technique, the positions of the eyes of the observer, the movable units of the light-flux-generating section 110 and the light-flux-controlling section 120 can be automatically controlled so that the light fluxes come in the positions.

Thereby, for example, in the case of providing the display apparatus in a driver's seat of an automobile, the position and the focus of the light device are adjusted according to the height of the driver, and thereby, drivers having various body types can appropriately observe the image. Alternatively, even in such a case as the driver moves his head to the left, right, front, or back, the light flux follows the movement thereof and the image can continue to be observed.

As described above, in the display apparatus 10 according to this embodiment, the position and the focus of the display region for the observer can be adjusted with high accuracy, and the display with high brightness and good visibility can be realized.

In particular, this exerts large effect in the cases that the irradiation region 112a to the observer 100 is narrowed and that only one eye 105 of the observer 100 is irradiated with the light flux 112.

For the image-taking section 150, for example, a CCD camera or a CMOS sensor or the like can be used. Moreover, when it is composed that a mirror which reflects visible light and through which infrared light is transmitted is used as the first mirror 122 and the image 101 of the observer 100 is image-taken by infrared light, needless noise in the image can be reduced and this is effective.

In FIG. 1, between the image-taking section 150 and the first mirror 122, an adjustment lens 151 configured to adjust magnitude of the image and the focus is provided, but it is sufficient that this adjustment lens 151 is provided according to need.

Moreover, a display section 160 configured to display the taken image may be further provided. Thereby, adjustment of the position and the focus of the irradiation region 112a of the light flux 112 to the observer 100 becomes easy. That is, if the light flux is out of the eye of the observer 100 in such a case as the irradiation region of the light flux is small, the observer 100 cannot watch the image reflected in the projection plate 210. In such a case, if the image of the observer 100 is displayed in the display section 160, the observer 100 adjusts the movable units of the light-flux-generating section 110 and the light-flux-controlling section 120 with watching the display section 160, and thereby, it becomes easy to appropriately adjust the position and the focus of the light flux.

However, when the taken image is image-treated and declination of the position or the focus of the irradiation region 112a to the observer 100 is automatically grasped and the result can be shown, the display section 160 is not necessarily required. For adjusting the focus from the taken image, various methods such as a method of detecting the phase difference of the taken image or a method of detecting contrast can be utilized. Moreover, on a display screen of the display section 160, cross bar or the like representing the center of the irradiation region 112a of the light flux 112 can be displayed. By adjusting the position of this to the one eye 105 of the observer 100, the position adjustment of the irradiation region 112a can be easily performed.

Moreover, this display apparatus 10 can be applied to the HUD by setting the projection plate 210 to be a front glass (windshield) of a vehicle or the like. At this time, a high reflection layer (light-reflecting layer having translucency) is provided in a part of the front glass and the light flux 112 can be irradiated to the part.

In the display apparatus 10 illustrated in FIG. 1, the projector 113 and the image unit 114 can move in the axial direction of the light flux 112, but it is also possible that any one thereof can move and that they may be movable not only in the axial direction but also in another direction. Moreover, it can be composed that as the light-flux-generating section 110, lens or the like is further provided and the position thereof is movable and the focus is adjusted. Moreover, in the example of FIG. 1, the second mirror 124 is movable, but another optical component composing the light-flux-controlling section 120 may be movable.

As the light-flux-generating section 110, as well as the above-described combination of the projector and the image unit, various types can be used. For example, a combined structure of one of various light sources such as a laser, an LED, and a halogen lamp and one of optical elements such as a movable mirror or MEMS by which the light flux generated by the light source is scanned can be used. Moreover, a combined structure one of various light sources and an optical switch such as an LCD, or the like can be used. Moreover, a display of one of various methods such as a CRT (Cathode Ray Tube), a VFD (Vacuum Fluorescent Display), a PDP (Plasma Display Panel), an EL (Electro Luminescence) display apparatus, and an organic EL display apparatus can be used. And, the light-flux-generating section 110 can also be composed by a structure in which they and an optical component are combined.

Moreover, by controlling the light flux 112, various optical components can be used in the light-flux-controlling section 120 configured to control the light flux 112 to come only in the head 104 of the observer 100. For example, a flat-plate mirror, a concave-face mirror, a prism, a Fresnel lens, or the like which reflects, refracts, and semi-transmits a light flux can be used. Moreover, a combination of lens and aperture, a lenticular plate, a holographic diffuser, a diffusion screen, a micro-lens array, a graded index type micro-lens, various prism sheets, a louver sheet, a plurality of arranged wave guides of truncated triangular pyramid, or the like can be used. And, the above-described various optical components can be combined and used.

The light-flux-generating section 110 and a part of optical components composing the light-flux-controlling section 120 may be used together, and the light-flux-generating section 110 and a part of optical components composing the light-flux-controlling section 120 may be mixed and arranged in the axis of the light flux 112. That is, these optical components can be used together, replaced, and deleted in the technically possible range.

### Comparative Example

FIG. 2 is a schematic view illustrating the structure of a display apparatus of Comparative example. For each of figures after FIG. 2, the same signs are appended to the same components as described above with respect to a figure presented previously, and the detailed explanation will be appropriately omitted.

As shown in FIG. 2, the display apparatus 80 of Comparative example has the light-flux-generating section 110 and the light-flux-controlling section 120, but the mechanism image-taking the observer 100 is not provided. Therefore, if it is attempted to adjust the position and the focus of the irradiation region 112a to the observer 100, the observer 100 cannot perform the adjustment because the observer 100 cannot recognize the position of the head 104 of the observer 100 with respect to the light flux 112.

If the image-taking section is not obtained from the optical elements composing the light-flux-generating section 110 or the light-flux-controlling section 120 and for example provided above or laterally to the observer 100, the image 101 cannot be image-taken from the front face of the observer 100 and also the image-taking axis 152 and the axis of the light flux 112 do not correspond, and therefore, when it is attempted to grasp the position of the observer 100 from the taken image and to change the movable optical components composing the light-flux-generating section 110 or the light-flux-controlling section 120 and thereby to adjust the position and the focus of the irradiation region 112a to the observer 100, the accuracy is bad.

By contrast, in the display apparatus 10 illustrated in FIG. 1, the image 101 of the observer 100 is obtained from the first mirror 122 (namely, at least one of the optical components composing the light-flux-generating section 110 or the light-flux-controlling section 120). Thereby, the image 101 can be taken from the front face (visual line) of the observer 100. And, the image-taking section 150 is disposed in the extension of the axis of the light flux 112, and the image 101 of the observer 100 can be taken in the extension of the axis of the light flux 112. Thereby, the position and the focus of the irradiation region 112a of the light flux 112 to the observer 100 can be adjusted with high accuracy.

### Second Embodiment

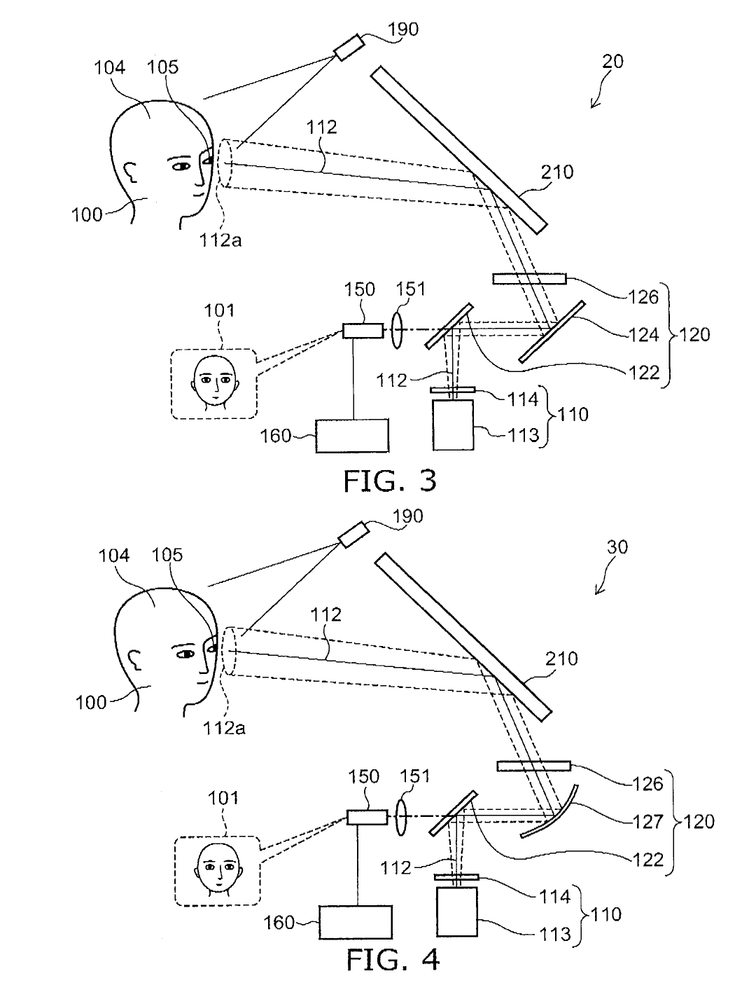

FIG. 3 is a schematic view illustrating the structure of a display apparatus according to a second embodiment of the invention.

As shown in FIG. 3, in the display apparatus 20 of the second embodiment of this invention, the display apparatus 10 illustrated in FIG. 1 is provided further with an infrared LED 190 of irradiating the observer 100. Thereby, also in such a dark circumstance as nighttime, the image 101 of the observer 100 can be taken.

Thereby, by the display apparatus 20, the position and the focus of the display region with respect to the observer can be adjusted with high accuracy stably even in a dark circumstance, the display with high brightness and good visibility can be realized. It is preferable that the display apparatus 20 is applied to the HUD that is also used in nighttime.

The light source (illumination section) irradiating the observer 100 may be one except for the infrared LED, and various lamps can be used.

### Third Embodiment

FIG. 4 is a schematic view illustrating the structure of a display apparatus according to a third embodiment of the invention.

As shown in FIG. 4, in the display apparatus 30 of the third embodiment of this invention, the second mirror 124 in the display apparatus 20 illustrated in FIG. 3 is replaced by a concave mirror 127. In this case, by a curvature factor of the concave mirror 127, the divergence angle of the light flux 112 can be controlled, and the irradiation region 112a of the light flux 112 to the observer 100 can be controlled, and the control of the irradiation region 112a becomes efficient. Moreover, the apparatus structure can be downsized. The concave mirror 127 is movable.

The display apparatus 30 enables the control of the light flux 112 to be efficient and downsized and enables the position and the focus of the display region with respect to the observer to be adjusted with high accuracy, and thereby, the display with high brightness and good visibility can be realized.

### Fourth Embodiment

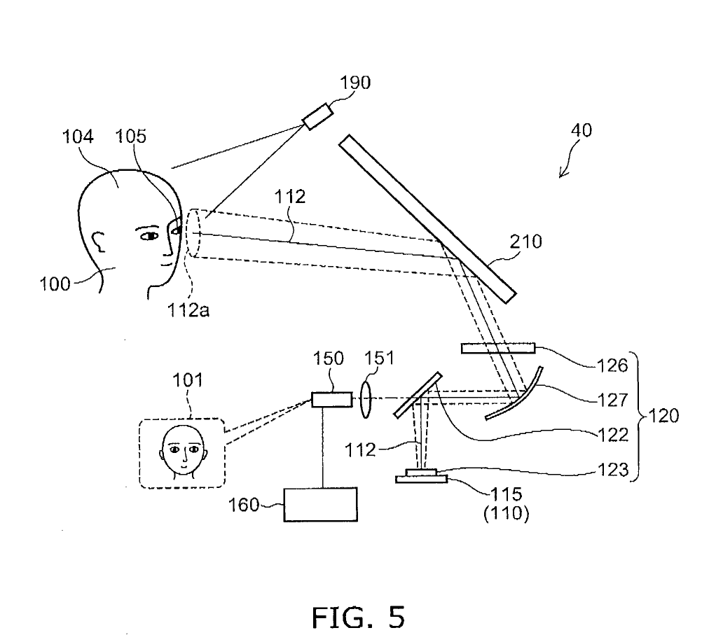

FIG. 5 is a schematic view illustrating the structure of a display apparatus according to a fourth embodiment of the invention.

As shown in FIG. 5, in the display apparatus 40 of the fourth embodiment of this invention, the projector 113 of the light-flux-generating section 110 in the display apparatus 30 illustrated in FIG. 4 is replaced by an LCD 115 having a back light. And, in front of the LCD 115, a lenticular plate 123 configured to control a divergence angle of the light flux is disposed. And, the LCD 115 and the lenticular plate 123 are movable along the axial direction parallel to the light flux 112. Thereby, the apparatus structure can be downsized.

Thereby, the display apparatus 40 has a small size and enables the position and the focus of the display region with respect to the observer to be adjusted with high accuracy, and can realize the display with high brightness and good visibility.

In the above-described display apparatuses 30, 40 according to third and fourth embodiments, the concave mirror 127 can play a function of the lens 126. Therefore, in the display apparatuses 30 and 40 illustrated in FIGS. 4 and 5, the lens 126 is not necessarily provided and can be provided according to need.

### Fifth Embodiment

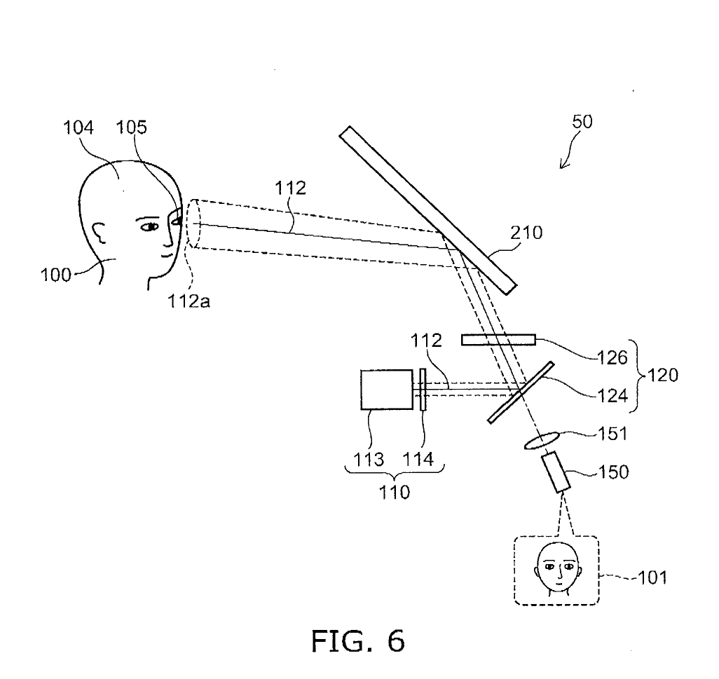

FIG. 6 is a schematic view illustrating the structure of a display apparatus according to a fifth embodiment of the invention.

As shown in FIG. 6, in the display apparatus 50 of the fifth embodiment of this invention, the image-taking section 150 is provided in the back surface of the mirror 124. That is, the image-taking section 150 can take an image 101 of the observer 100 obtained through the second mirror 124. In this case, if a mirror reflecting the visible light and transmitting infrared light is used as the second mirror 124 and it is composed that the image 101 of the observer 100 is taken by the infrared light, needless noise in the image can be reduced and this is effective.

The display apparatus 50 illustrated in FIG. 6 also enables the position and the focus of the display region with respect to the observer to be adjusted, and the display with high brightness and good visibility can be realized.

### Sixth Embodiment

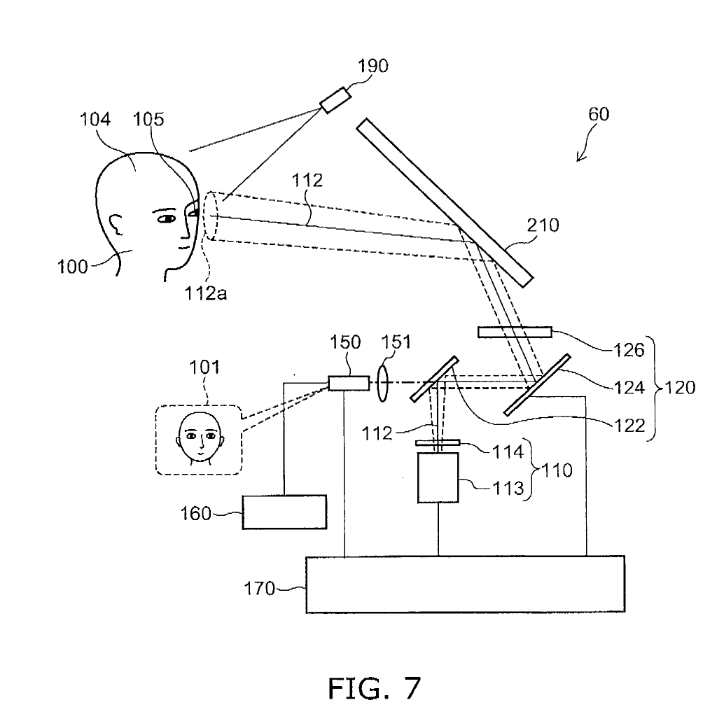

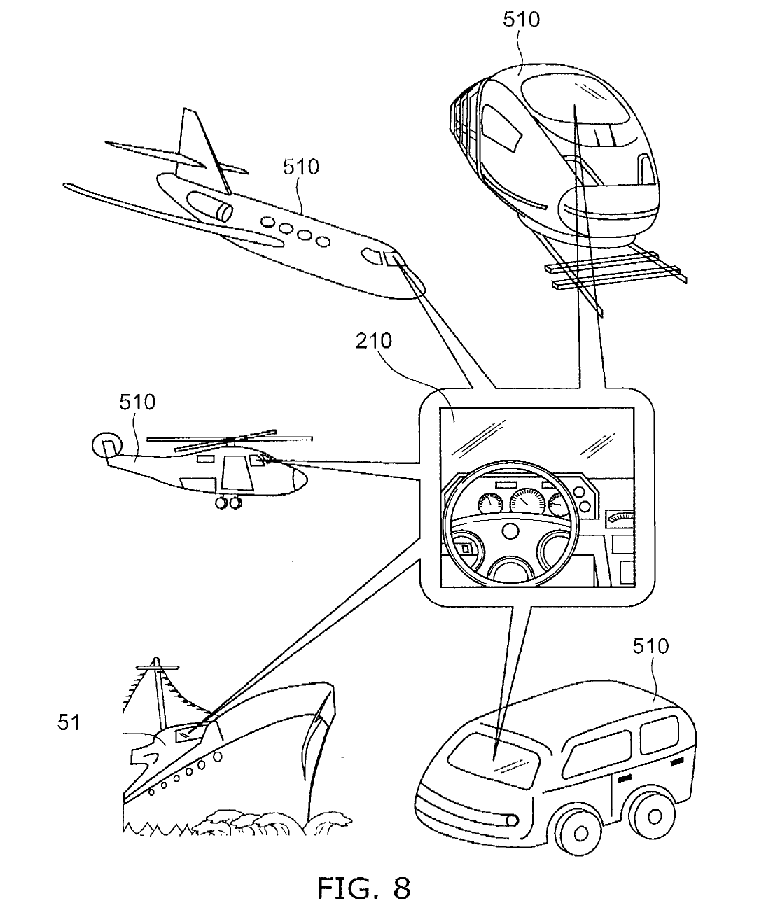

FIG. 7 is a schematic view illustrating the structure of a display apparatus according to a sixth embodiment of the invention.

As shown in FIG. 7, in the display apparatus 60 of the sixth embodiment of this invention, a control section 170 configured to control at least one of the light-flux-generating section 110 and the light-flux-controlling section 120 by image-treating the image 101 of the observer 100 based on the image 101 taken by the image-taking section 150 to specify the position of the observer 100 is further provided in the display apparatus 20 illustrated in FIG. 3.

In the above-described image treatment, such a method for specifying positions of the both eyeballs, nose position, mouth position, and so forth as the characteristic points of the face of the observer 100 and thereby specifying the position of the head, particularly, the eye of the observer 100 as described in Patent document 2 can be used. Thereby, the position of the observer 100 (particularly position of the eye 105) can be specified.

And, the light flux 112 can be controlled by following the specified position of the observer 100 (particularly, position of the eye), and the control can be performed so that the irradiation region 112a of the light flux 112 is arranged in the head 104 (particularly, eye 105) of the observer 100. Moreover, the focus of the light flux 112 can be adjusted. Specifically, at least one of the movable optical components composing the light-flux-generating section 110 and the movable optical components composing the light-flux-controlling section 120 is controlled.

In the display apparatus 60 illustrated in FIG. 7, the light-flux-generating section 110 is movable along the axial direction parallel to the light flux 112, and thereby, the focus is adjusted. That is, the difference between the position of the observer 100 and the position of the focus of the light flux 112 is grasped and compensation signal is generated based on the difference, and by the compensation signal, the adjustment section (not shown) connected to the light-flux-generating section 110 is driven, and the position of the light-flux-generating section 110 is controlled. In this case, by the various methods such as a method for detecting the phase difference of the taken image or a method of detecting contrast, the difference between the position of the observer 100 and the position of the focus of the light flux 112 can be obtained. Moreover, the focus driving unit such as a CCD camera used for the image-taking section 150 and the driving unit of the light flux 112 can be coupled.

Moreover, the second mirror 124 is movable, and thereby, the position of the irradiation region 112a can be adjusted. In this case, based on the difference between the specified position of the observer 100 and the appropriate position of the irradiation region 112a of the light flux 112, the compensation signal is generated, and by the compensation signal, the adjustment section (not shown) changing the position or angle of the second mirror 124 can be driven to control the second mirror 124.

In the above description, by providing the display section 160 configured to display the taken image, the image-taking state and the automatic-adjustment state can be confirmed and the stable adjustment of the light flux can be performed.

In adjusting the light flux to one-eye, in order to adjust the light flux to the dominant eye, a function for selecting the adjustment to the right or left eye may be provided.

Thereby, when the head 104 of observer 100 moves, the movement can be automatically followed to adjust the irradiation region 112a and to adjust the focus, and thereby, to enable the position and the focus of the display region with respect to the observer to be stably adjusted with high accuracy, and the display with high brightness and good visibility can be realized.

For example, when the above-described various display apparatuses of the embodiments are used in the state that the observation attitude is fixed like the HUD, by setting the irradiation region 112a of the light flux 112 to the observer 100 to be vertically long, the adjustment of the irradiation region 112a of the light flux 112 can be performed only in the horizontal direction. Thereby, the control of the position of the irradiation region 112a becomes easy and not only the apparatus can be easily used but also lowering of cost can be achieved.

The above-described projection plate 210 explained in the display apparatuses of the embodiments can be a front glass (window shield) or the like of a vehicle or the like, and various types of driving information is displayed in the front glass at the same time as the image information of the background field outside the front glass of a vehicle or the like, and the driving information can be visually recognized. In a part of the front glass, a high reflection layer (light reflection layer having translucency) can be provided.

FIG. 8 is a schematic view illustrating movable bodies according to the invention.

As shown in FIG. 8, for example, a window of one of various mobile apparatus 510 such as vehicle, automobile, train, ship, helicopter, and plane can be the projection plate 210. That is, the mobile apparatus having the above-described display apparatus of the embodiments and the projection plate 210 to which the light flux 112 output from the display apparatus is projected can be composed.

Thereby, the position and the focus of the display region with respect to the observer can be adjusted with high accuracy, and the display with high brightness and good visibility can be realized, and the good visibility is realized, and movable bodies which are safe and can be driven with high efficiency can be provided.

As described above, the embodiments of this invention has been explained with reference to specific examples. However, this invention is not limited to the specific examples. For example, the specific structure of each of the components composing the display apparatuses and the movable bodies is included in the scope of this invention, as long as this invention can be carried out by appropriate selection from the known range by those skilled in the art and the same effect can be obtained.

Moreover, combination of two or more components of the respective specific examples in the technically possible range is included in the scope of this invention as long as including the spirit of this invention.

In addition, all of the display apparatuses and movable bodies that can be carried out with appropriately design-modified by those skilled in the art based on the display apparatuses and the movable bodies described above as the embodiments of this invention belong to the scope of this invention as long as including the spirit of this invention.

In addition, it is understood that those skilled in the art can achieve various changed examples and modified examples and that the changed examples and the modified examples belong to the scope of this invention.

1. A display apparatus comprising:
a light-flux-generating section configured to generate a light flux containing image information;
a light-flux-controlling section configured to control the light flux and making the light flux come toward a head of an observer; and
an image-taking section configured to take an image of the observer,
at least one of the light-flux-generating section and the light-flux-controlling section including a movable unit in which at least one of position and focus of the light flux can be adjusted with the observer watching the taken image by the image-taking section.

2. The display apparatus according to claim 1, wherein the image-taking section takes the image in an extension of an axis of the light flux.

3. The display apparatus according to claim 1, wherein the image-taking section takes the image by infrared light.

4. The display apparatus according to claim 1, wherein the image-taking section detects at least one of light transmitting an optical component included in the light-flux-controlling section and light reflected by the optical component.

5. The display apparatus according to claim 1, wherein the display section configured to display the taken image of the observer.

6. The display apparatus according to claim 1, wherein the light-flux-controlling section makes the light flux come only in one-eye of the observer.

7. The display apparatus according to claim 1, further comprising an illumination section configured to irradiate the observer with infrared light.

8. The display apparatus according to claim 6, wherein the illumination section is LED emitting infrared light.

9. The display apparatus according to claim 1, wherein the light-flux-controlling section has at least one of a concave mirror and a lenticular plate.

10. A display apparatus comprising:
a light-flux-generating section configured to generate a light flux containing image information;
a light-flux-controlling section configured to control the light flux and making the light flux come toward a head of an observer;
an image-taking section configured to take an image of the observer; and
a control section configured to control at least any one of the light-flux-generating section and the light-flux-controlling section based on the taken image by the image-taking section to adjust at least any one of position and focus of the light flux.

11. The display apparatus according to claim 10, wherein the image-taking section takes the image in an extension of an axis of the light flux.

12. The display apparatus according to claim 10, wherein the image-taking section takes the image by infrared light.

13. The display apparatus according to claim 10, wherein the image-taking section detects at least one of a light transmitting an optical component included in the light-flux-controlling section and a light reflected by the optical component.

14. The display apparatus according to claim 10, wherein the display section configured to display the taken image of the observer.

15. The display apparatus according to claim 10, wherein the light-flux-controlling section makes the light flux come only in one-eye of the observer.

16. The display apparatus according to claim 10, further comprising an illumination section configured to irradiate the observer with infrared light.

17. The display apparatus according to claim 16, wherein the illumination section is LED emitting infrared light.

18. The display apparatus according to claim 10, wherein the light-flux-controlling section has at least one of a concave mirror and a lenticular plate.

19. A mobile apparatus comprising:
a display apparatus including: a light-flux-generating section configured to generate a light flux containing image information; a light-flux-controlling section configured to control the light flux and making the light flux come toward a head of an observer; and an image-taking section configured to take an image of the observer, at least one of the light-flux-generating section and the light-flux-controlling section including a movable unit in which at least one of position and focus of the light flux can be adjusted with the observer watching the taken image by the image-taking section; and
a projection plate to which the light flux output from the display apparatus is projected.

20. A mobile apparatus comprising:
a display apparatus including, a light-flux-generating section configured to generate a light flux containing image information, a light-flux-controlling section configured to control the light flux and making the light flux come toward a head of an observer, an image-taking section configured to take an image of the observer, and a control section configured to control at least any one of the light-flux-generating section and the light-flux-controlling section based on the taken image by the image-taking section to adjust at least any one of position and focus of the light flux; and
a projection plate to which the light flux output from the display apparatus is projected.
